(19) United States
(12) Patent Application Publication
(10) Pub. No.: US 2004/0074371 A1
(43) Pub. Date: Apr. 22, 2004

(54) Semi-free floating mounting system for the bars of a vibe

(76) Inventor: George L. Byars, Houston, TX (US)

Correspondence Address: GEORGE L. BYARS, 5118 PRAIRIE RIDGE RD., HOUSTON, TX, 77053-4434, US

(21) Appl. No.: 10/199,575

(22) Filed: Oct. 22, 2002

(51) Int. Cl. G10D 13/08

(52) U.S. Cl. 84/402

(57) ABSTRACT

An assembly for mounting bars of keyboard percussion instruments comprising: (a) rods of 90 degree angle mounted to a keyboard percussion frame so as to provide support for bars (b) springs for allowing movement of said bars by being through said bars and coupled to said rods.

### BACKGROUND

1. Field of Invention

This invention relates to the vibe, specifically to an improved mounting system for the bars of the vibe.

2. Description of Prior Art

Traditionally, the main keyboard percussion instruments, which are the vibe, marimba, and xylophone, have had their bars mounted by means of a nylon cord inserted horizontally through holes, and this cord is held up by supports attached to the transverse cross members of the frame. At the end of the row of natural bars—similar to the white keys on the piano, and at the end of the row of sharp or flat bars—similar to the black keys on the piano, the nylon cord for each row has tension applied to it by two springs hooked together. Every bar length has its own two node points or dead areas that extend from one side of the bar to the other. These node points or dead areas are to be avoided when performing on the instrument, because if the bars are struck at these dead areas, the bar will not vibrate much. There is one node point a set distance from one end of the bar, and another node point the same distance from the other end of the bar. The distance from each end of the bar is dependent upon the length of the bar. At these node points, one can hold the bar up in the air by gripping the sides of the bar with the tips of two fingers, strike the bar with a mallet, and the bar will vibrate. If one grips at points towards the middle or end of the bar from this point and the bar is struck, the gripping acts like a damper—the further away from the node points, the more dampening. It is at these node points that the holes are drilled through the bars, or should be, but because one long length of cord is used for all the naturals, and another long length of cord is used for all the sharps or flats, the holes have to be drilled at angles that conform to the angles of the transverse cross members; some holes are drilled at the wrong place, especially where the bars are mounted to the outside transverse cross members because these have the greatest amount of angle. Just like the dampening caused by gripping at points other than the node points, the cord being at points other than the node points also dampens.

Additional dampening of the bars is caused by the cord being dampened by the supports; if the cord does not move with the bars, it stops the bars from moving. All the bars are dampened some, but some more that others. Players of the vibe want as much sustain as possible—especially uniform sustain. It is unprofessional sounding when a vibist plays a chord by hitting four bars simultaneously with the intention of letting them all vibrate for a long time just to have two bars stop vibrating after a short time while the other two continue to vibrate. Volume also suffers when the bars do not vibrate properly.

All the bar mounting systems heretofore known suffer from a number of disadvantages:

(a) The bars supports lack adjustability; there is no way to move the bars backwards or forwards, or to move one or both ends of the bars up or down.

Many players have different tastes as to how they want to play the vibe.

Some players might want to have the inner ends of the bars slightly lower in order to make dampening with a mallet from natural to sharp or flat more smooth. It is not easy for a manufacturer to smooth out the dampening with a mallet from natural to sharp or flat by a player by making the gap between naturals and sharps or flats even and narrow. If a bar is cut slightly too long, it has to be shortened and retuned. If it is cut slightly too short, there is nothing that can be done and an uneven, overly wide gap will have to be tolerated, or another bar has to be machined and tuned. Also, any unevenness of a vibes damper can be compensated for by raising or lowering the bars.

(b) The bar supports require expensive machinery and lots of skilled labor time to machine; a vertical mill is needed.

Labor costs are high because mounting systems that require the bars holes to be drilled at angles do not lend themselves as easily to being produced by automation. It is difficult to drill holes the traditional way, with a drill press, at an angle, because much measuring and marking off and unusual clamping and alignment in a vise is necessary and a drill does not bore through an aluminum bar easily at an angle.

© The dampening effects caused by the cord being dampened by the supports, and the holes not being at the node points means less volume and sustain.

(d) Kinetic energy is lost because the collision between the mallet and bar is inelastic; kinetic energy is converted to heat energy because of the friction produced by the molecules of the mallet head as they move past one another when it distorts, and this distortion or flattening out over the surface of the bar as it impacts also has a dampening effect upon the bar.

Mallets that have hard heads do not loose as much energy or dampen as much, but because of the law of conservation of linear momentum, some of the force on the bars causes an equal but opposite reaction force upon the mallets—shaft vibration makes them uncomfortable to the hands of players of the instrument.

### OBJECTS AND ADVANTAGES

Accordingly, besides the objects and advantages of a semi-free floating bar mounting system described in my above patent, a couple of objects and advantages of the present invention are:

to provide adjustability up and down or backwards and forwards of the bars;

to provide a means of reducing production costs;

to provide a means of increasing sustain and volume;

to provide a means of decreasing energy loss;

to provide a means of increasing the comfort of players;

Still further objects and advantages will become apparent from a consideration of ensuing descriptions and drawings.

### DRAWING FIGURES

FIG. 1 shows a sideways view of all four transverse cross members with the hardware for mounting a natural and a sharp or flat bar.

FIG. 2 shows an above view of a section of a row of naturals with an emphasis on showing how the elastic is connected and the holes in the bars not being at an angle.

FIG. 3 is an example of prior art.

### REFERENCE NUMERALS IN DRAWINGS

10 transverse cross member

12 spring

14 bar supports

16 nut

18 washer

20 end support member

22 bar

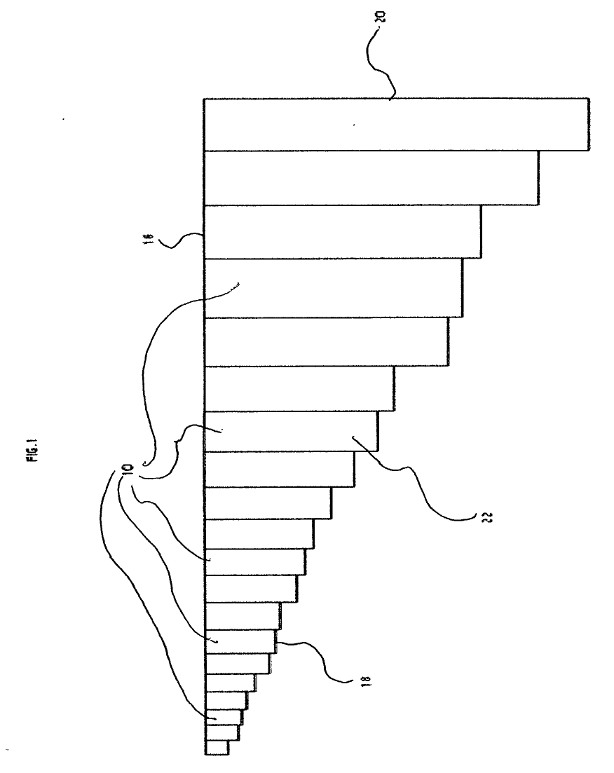

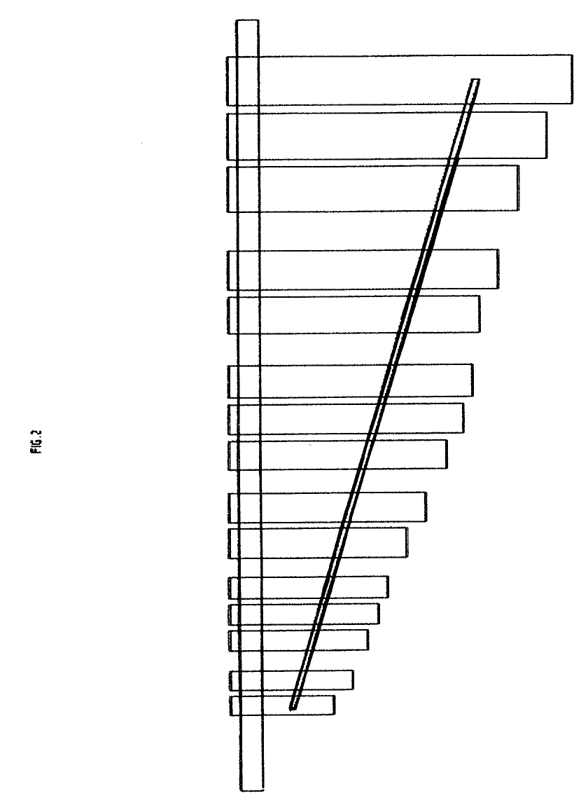

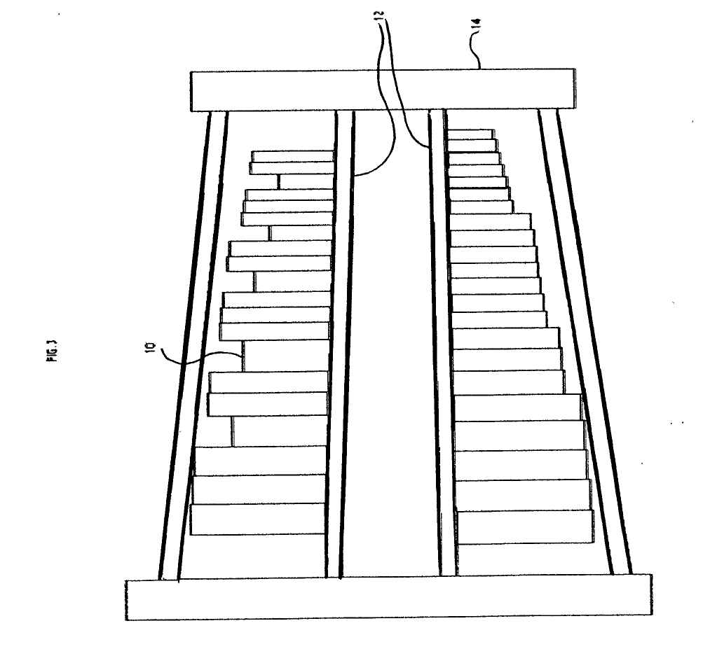

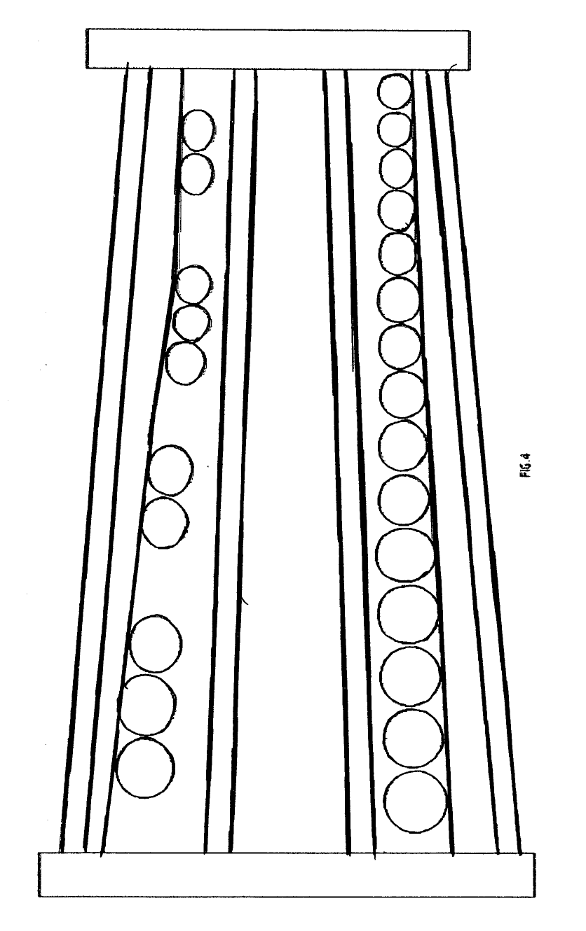

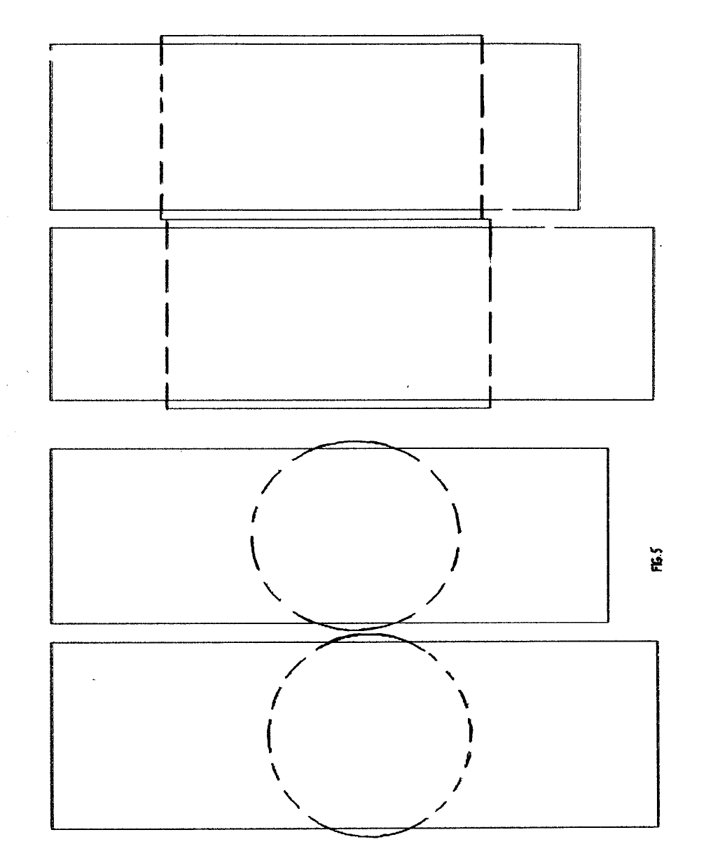

### DESCRIPTION—FIGS. 1 AND 2

In FIG. 1, the bar supports (14) are made of allthread which is 6/32″ in diameter. A slightly bigger size could be used without any problem. Their lengths can be cut with a pair of wire cutters if they are carbon steel. They will have to be cut with a power tool using an abrasive blade if they are stainless steel. The length of each is going to be dependent upon the height of the transverse cross members (10), but one should start out with cutting the allthread (14) to be 3″ plus the height of transverse cross member (10)—this is longer than necessary, but it is better to have them too long than too short, and the extra length can easily be cut off after they have been installed. A 90 degree bend is made using fingers or a pipe bending tool allowing about 1 to 1½″ for supporting the bar. Holes in the transverse cross members (10) should be drilled so that when the bars (22) are installed, there is about an ⅛″ gap between each row of bars (22) and the springs are at about the middle of the horizontal part of the bar supports. After the holes are drilled, the bars support (14) insertion of bar supports and installation of nuts (16) and washers (18) can be done.

Many spring (12) sizes can be used, but the preferred embodiment is 3/16″ outside diameter with wire diameter of 0.022″. The length graduation is 1¾″, 1½″, 1⅜″, and 1¼″. Noise from metal to metal contact is eliminated by wrapping teflon tape around the bar supports (14) and inserting rubber tubing through the holes in the bars (22). A tool to pull the springs (12) through can be a bar support (14) with a notch cut near the end of the long length.

From the description above, a number of advantages of my semi-free floating bar mounting system become evident:

The ability to raise and lower either or both ends of the bars and to move the bars backwards and forwards means that the tastes of all individual players can be satisfied, and the gap between the naturals and sharps or flats will be even and narrow, making the instrument easier to play.

Not having to buy expensive machinery to produce bar supports, the ability to be efficient with automation, and the ability to lower time spent machining the traditional way by eliminating many steps involved, lower production costs.

The holes and elastic string being where the node points are, and the elastic string vibrating with the bar as it vibrates allow the bar to vibrate better, producing more sustain and volume.

More kinetic energy is transferred from mallet to bar when the bar moves away from the mallet after being struck; the spring causes this collision to be more elastic.

The kinetic energy produced with a harder mallet is not directed to the harder mallet by the bar upon impact when the bar moves in the same direction as the force applied to it; the spring allowing the bar to move in the same direction eliminates uncomfortable mallet shaft vibration.

### OPERATION—FIGS. 1 AND 2

The manner of playing a vibe with a semi-free floating bar mounting system is identical to that for vibes in present use. Namely, one exerts a downward force with a mallet. The mallet head impinges upon the bar (22) forcing it downward slightly as the springs (12) stretch out, creating transverse waves through the bar (22), which then create sound waves through air.

### SUMMARY, RAMIFICATIONS, AND SCOPE

Although the vibe can benefit the most from the semi-free floating bar mounting system, the marimba, and xylophone can also benefit. Accordingly, the reader will see that the semi-free floating bar mounting system can increase the sustain and volume of vibe bars. Furthermore, the semi-free floating bar mounting system has the additional advantages in that

it permits a savings in production costs by lowering the cost of labor and machinery;

it allows more adjustability;

it prevents loss of kinetic energy;

provides a higher level of comfort to players of the instrument.

Although the description above contains many specificities, these should not be construed as limiting the scope of the invention but as merely providing illustrations of some of the presently preferred embodiments of this invention. For example, besides springs, short lengths of mini stretch cords or elastic string could be used. The bar supports could be made of rods with notches or the ends of the horizontal part could be bent up at the end and not as long, the bar supports could be mounted horizontally etc.

Thus the scope of the invention should be determined by the appended claims and their legal equivalents, rather than by the examples given.

1. Claim 1 or abstract, cancel and substitute new claim 2, as follows:
A mounting system for the bars of keyboard percussion instruments comprising:
a. flexible devices extending widthwise through holes in bars for allowing said bars to vibrate more freely and for allowing a more efficient transfer of energy to said bars after being struck,
b. means for supporting said flexible devices.
